(19) United States
(12) Patent Application Publication
(10) Pub. No.: US 2006/0266468 A1
(43) Pub. Date: Nov. 30, 2006

(54) Method for facilitating the routing of radio frequency cables

(75) Inventor: Brian M. Germano, Endicott, NY (US)

Correspondence Address: DILLON & YUDELL LLP, 8911 NORTH CAPITAL OF TEXAS HWY, SUITE 2110, AUSTIN, TX, 78759, US

(73) Assignee: Lockheed Martin Corporation, Bethesda, MD (US)

(21) Appl. No.: 11/140,782

(22) Filed: May 31, 2005

(51) Int. Cl. B32B 37/00; B32B 38/10; B32B 37/12; C09J 5/00

(52) U.S. Cl. 156/257; 156/293; 156/305; 156/291

(57) ABSTRACT

A method for facilitating the routing of flexible cables is disclosed. A minimum cable bend requirement of a flexible cable is initially ascertained. Then, a cable routing trough is formed into a location on which the flexible cable is to be attached according to a cable route. The ascertained minimum cable bend requirement is observed by the cable route. Subsequently, the flexible cable is routed inside the cable routing trough. Finally, the flexible cable is bounded to the cable routing trough.

### BACKGROUND OF THE INVENTION

1. Technical Field

The present invention relates to radio frequency (RF) cables in general, and in particular to RF cable for connecting RF components. Still more particularly, the present invention relates to a method for facilitating the routing of RF cables connecting between RF components.

2. Description of Related Art

Radio frequency (RF) components are commonly found in high-end high performance electronic equipments, such as avionics equipments. Typically, flexible or semi-rigid RF cables are utilized to interconnect RF components. After an RF cable has been positioned on a board or chassis for connecting two RF components, multiple cable clamps are then utilized to secure the RF cable in place.

RF cables are similar to coaxial cables but tend to be more fragile. For example, the minimum cable bend requirement of an RF cable must always be maintained during the routing and mounting of the RF cable. The minimum cable bend requirement is defined as the smallest radius in a bend that an RF cable can withstand before an occurrence of electrical degradation and/or mechanical degradation. Incidentally, if the minimum cable bend requirement of an RF cable is violated during the installation of the RF cable, any electronics assembly that uses the RF cable will subsequently experience electrical/mechanical failures.

Consequently, it would be desirable to provide a method for facilitating the routing of RF cables such that the minimum cable bend radii associated with the installation of the cables can always be maintained.

### SUMMARY OF THE INVENTION

In accordance with a preferred embodiment of the present invention, a minimum cable bend requirement of a flexible cable is initially ascertained. Then, a cable routing trough is formed into a location on which the flexible cable is to be attached according to a cable route. The ascertained minimum cable bend requirement is observed by the cable route. Subsequently, the flexible cable is routed inside the cable routing trough. Finally, the flexible cable is bounded to the cable routing trough.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a high-level logic flow diagram of a method for facilitating the routing of a flexible radio frequency (RF) cable, in accordance with a preferred embodiment of the present invention;

FIG. 2 is a graphical illustration of a chassis cover having several cable routing troughs for receiving flexible RF cables, in accordance with a preferred embodiment of the present invention; and

FIG. 3 is a cross-sectional view of one of the cable routing troughs from FIG. 2, in accordance with a preferred embodiment of the present invention.

### DETAILED DESCRIPTION OF A PREFERRED EMBODIMENT

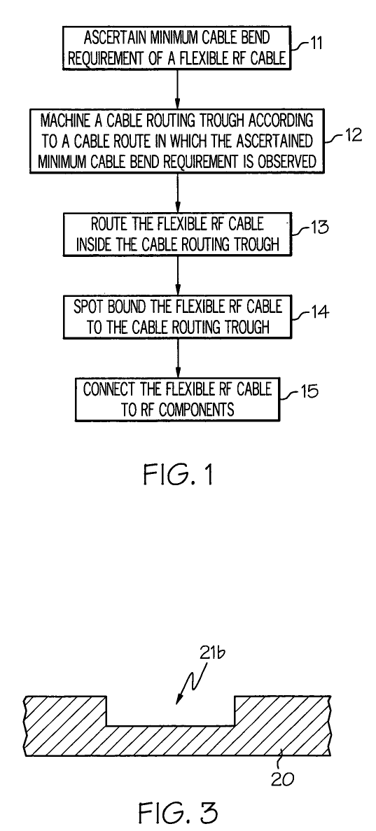

Referring now to the drawings and in particular to FIG. 1, there is illustrated a high-level logic flow diagram of a method for facilitating the routing of a flexible radio frequency (RF) cable, in accordance with a preferred embodiment of the present invention. Initially, the minimum cable bend requirement of a flexible RF cable is ascertained, as shown in block 11. The minimum cable bend requirement typically depends on the type of flexible RF cable being used.

Then, a cable routing trough is machined into a location on which the flexible RF cable is to be attached according to a cable route, as depicted in block 12. Such location may include a board, a cover, a chassis, etc. The machining can be performed by a drill and other machining equipment that are well-known to those skilled in the art. The cable route, which is planned by a designer, physically defines a route in which the flexible RF cable will be placed during cable installation. The cable route includes turns and bends that are preferably less than the minimum cable bend requirement for the flexible RF cable. Because the machined cable routing trough tracks the cable route, the machined cable routing trough does not violate the minimum cable bend requirement of the flexible RF cable either.

Subsequently, an assembler is used to route the flexible RF cable inside the cable routing trough from one RF termination to another, as shown in block 13. After the cable routing has been completed, the assembler is used to spot bound the RF cable to the cable routing trough in order to secure the RF cable within the cable routing trough, as depicted in block 14. The spot bounding is preferably performed via an appropriate adhesive. The flexible RF cable can then be connected to various RF components, as shown in block 15.

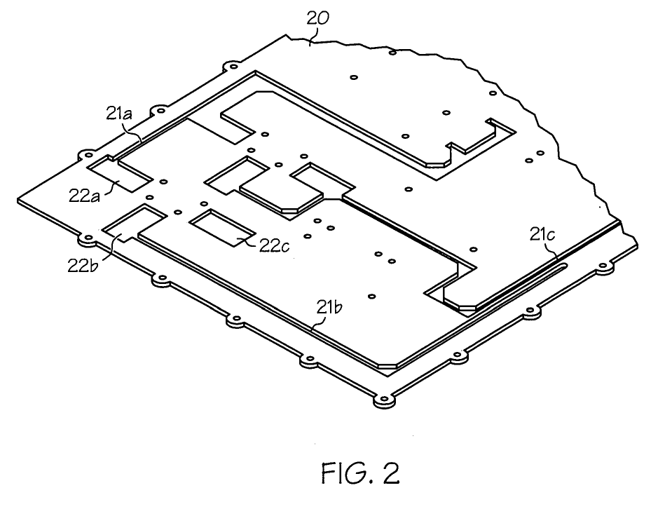

With reference now to FIG. 2, there is illustrated a chassis cover having several cable routing troughs for receiving flexible RF cables, in accordance with a preferred embodiment of the present invention. As shown, cable routing troughs 21a-21c are machined into a chassis cover 20. Cable routing troughs 21a-21c include turns and bends that do not violate the minimum cable bend requirement of flexible RF cables. Large rectangular troughs, such as troughs 22a-22c are locations for receiving RF components.

Referring now to FIG. 3, there is a depicted a cross-sectional view of cable routing trough 21b between x and y, in accordance with a preferred embodiment of the present invention. As shown, the width of cable routing trough 21b is preferably larger than the depth. For the present embodiment, cable routing trough 21b is approximately 0.090 inch wide and 0.025 inch deep.

As has been described, the present invention provides cable routing troughs for facilitating the routing of flexible RF cables. The cable routing troughs of the present invention guarantees flexible RF cables to be formed with the correct minimum bend during installation.

One benefit of the present invention is that cable clamps and associated hardware can be eliminated because flexible RF cables are secured within cable routing troughs via spot bounding. The bonding of flexible RF cables to the cable routing troughs also provides a mechanical interface that allows uninterrupted electrical and mechanical operations in all environments, especially when vibrations, shocks and similar conditions can occur. Another benefit of having cable routing troughs is that weight reduction can be realized due to the removal of materials in making cable routing troughs.

While the invention has been particularly shown and described with reference to a preferred embodiment, it will be understood by those skilled in the art that various changes in form and detail may be made therein without departing from the spirit and scope of the invention.

What is claimed is:

1. A method for facilitating the routing of a flexible cable, said method comprising:
ascertaining a minimum cable bend requirement of a flexible cable;
forming a cable routing trough into a location on which said flexible cable is to be attached according to a cable route, wherein said ascertained minimum cable bend requirement is observed by said cable route;
routing said flexible cable inside said cable routing trough; and
bounding said flexible cable to said cable routing trough.

2. The method of claim 1, wherein said cable route is planned by a designer.

3. The method of claim 1, wherein said bounding is performed via an appropriate adhesive.

4. The method of claim 1, wherein said method further includes connecting said flexible cable to a plurality of components.

5. The method of claim 1, wherein said forming further includes machining said cable routing trough into a location on which said flexible cable is to be attached according to said cable route.

6. The method of claim 1, wherein said bounding further includes spot bounding said flexible cable to said cable routing trough.

7. The method of claim 1, wherein said flexible cable is a flexible radio frequency cable.

8. An apparatus for receiving electronics components, said apparatus comprising:
a plurality of flexible cables; and
a plurality of cable routing troughs for receiving said plurality of flexible cables, wherein said plurality of cable routing troughs are formed on a substrate according to a cable route in which an ascertained minimum cable bend requirement is observed.

9. The apparatus of claim 8, wherein said cable route is planned by a designer.

10. The apparatus of claim 8, wherein said substrate further includes rectangular cable routing troughs for receiving components.

11. The apparatus of claim 8, wherein said plurality of flexible cables are flexible radio frequency cables.

12. A substrate comprising:
a plurality of cable routing troughs for receiving a plurality of flexible cables, wherein said plurality of cable routing troughs are formed on said substrate according to a cable route in which an ascertained minimum cable bend requirement is observed.

13. The substrate of claim 12, wherein said cable route is planned by a designer.

14. The substrate of claim 12, wherein said substrate further includes rectangular cable routing troughs for receiving components.

15. The substrate of claim 12, wherein said plurality of flexible cables are flexible radio frequency cables.
